(19) United States
(12) Patent Application Publication
(10) Pub. No.: US 2008/0223186 A1
(43) Pub. Date: Sep. 18, 2008

(54) METHOD OF MANUFACTURING MULTI-LAYER INSULATION BLANKETS

(76) Inventors: Amelia Leichliter, Palm Bay, FL (US); JoAnn Marrell, West Melbourne, FL (US); Joseph Kreuzpaintner, Orlando, FL (US); Brynn Johnson, Melbourne, FL (US)

Correspondence Address: GRAY ROBINSON, P.A., P.O. Box 2328, FT. LAUDERDALE, FL, 33303-9998, US

(21) Appl. No.: 11/685,843

(22) Filed: Mar. 14, 2007

(51) Int. Cl. B26D 7/00

(52) U.S. Cl. 83/29

(57) ABSTRACT

This invention is directed to a method for manufacturing MLI blankets, and MLI blankets which reduce PIM, which employs an existing cutting apparatus to perform a substantially automated cutting process with minimum hand operations resulting in increased productivity, improved uniformity of the blanket shapes and cut patterns, and, elimination of the use of templates.

### FIELD OF THE INVENTION

This invention relates to a method of manufacturing multi-layer insulation blankets for space structures, and, more particularly, to a substantially automated method for uniformly cutting and assembling the layers of a multi-layer insulation blanket.

### BACKGROUND OF THE INVENTION

Multi-layer insulation (“MLI”) blankets are currently used in a wide variety of space structures to protect components from thermal exposure. The blankets consist of a number of thin, individual layers of insulation material laid one on top of the other in a stack. The stack is formed with cut patterns and in an overall shape to meet the requirements of a particular space structure.

The method currently employed in the manufacture of an MLI blanket involves the preparation of a drawing which specifies the number of layers, how they should be stacked, the overall shape of the blanket and the particular cut patterns required in the stack so that the blanket fits the area of the space structure to be protected. Initially, the layers of insulation material are laid out, one atop the other, as specified in the drawing. A polystyrene template formed in the desired shape and having the required cut patterns is then placed on top of the stack. An exact-o blade, scalpel, punch and/or other cutting tools are used to hand cut the overall shape and cut patterns in the stack, using the template as a guide. This process is labor intensive, time-consuming and subject to inconsistency. It also requires relatively skilled technicians to perform.

MLI blankets of the type discussed above have been identified as one potential source of passive intermodulation (“PIM”), particularly in advanced communication satellites. PIM is a passive nonlinear interference phenomenon, much like the intermodulation interference generated in active nonlinear components in radio frequency systems. The advent of communications satellites with multiple payloads integrated on a single satellite platform with complex antenna layouts have led to increased PIM threats. It is therefore desirable to construct MLI blankets in a way to mitigate PIM.

### SUMMARY OF THE INVENTION

This invention is directed to a method for manufacturing MLI blankets, and MLI blankets which reduce PIM, which employs an existing cutting apparatus to perform a substantially automated cutting process with minimum hand operations resulting in increased productivity, improved uniformity of the blanket shapes and cut patterns, and, elimination of the use of templates.

Details of the preferred embodiments of the method of this invention are discussed below. Generally, a commercially available cutting apparatus is employed having a drag blade, a wheel blade, a punch and other cutting devices mounted to a movable carriage above a vacuum table. In forming an MLI blanket according to the method of this invention, several layers of insulation material are laid onto the table, one on top of the other, and a sacrificial layer is then placed over the uppermost layer in the stack. The sacrificial layer holds the stack down while one or more cutting operations are performed by the cutting apparatus. The blanket is protected from tearing and ripping by the application of reinforcing material such as tape to both the exposed top and bottom layers of the stack in the area(s) immediately adjacent to holes and other cuts in the stack.

The fabrication of MLI blankets to minimize PIM employs generally the same procedure outlined above, with the addition of steps to first connect a number of inner layers to one another, and then to secure larger top and bottom outer layers about the inner layers so that the peripheral edges of the two outer layers are sealed together.

Although some hand operations are required by the method of this invention, such operations are minimized and may be performed by less skilled technicians than had been required with existing MLI blanket fabrication techniques. Additionally, the automated cutting apparatus is more accurate than prior hand-cut operations, thus producing blankets which are more uniform and closer to the specifications from the drawing.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a schematic, block diagram of the method of fabricating an MLI blanket according to this invention; and

FIG. 2 is a schematic, block diagram of the method of fabricating an MLI blanket with PIM mitigation.

### DETAILED DESCRIPTION OF THE INVENTION

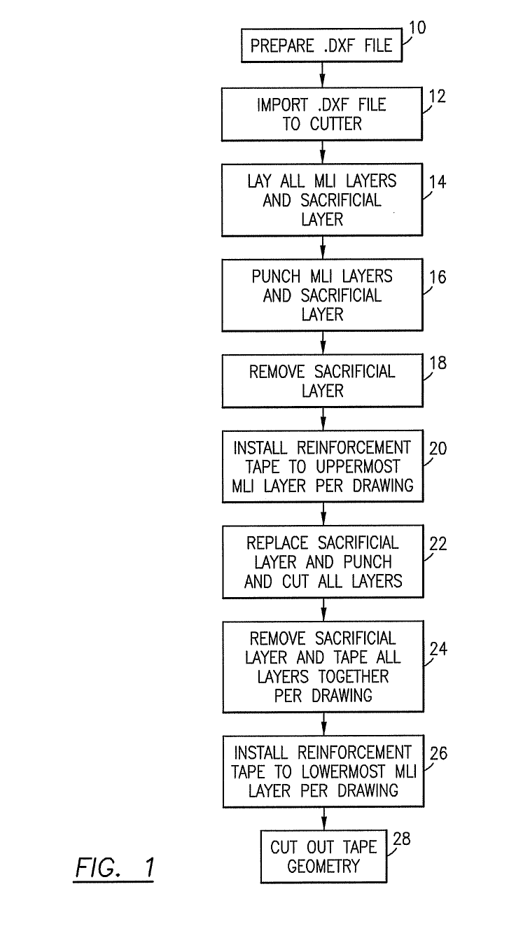

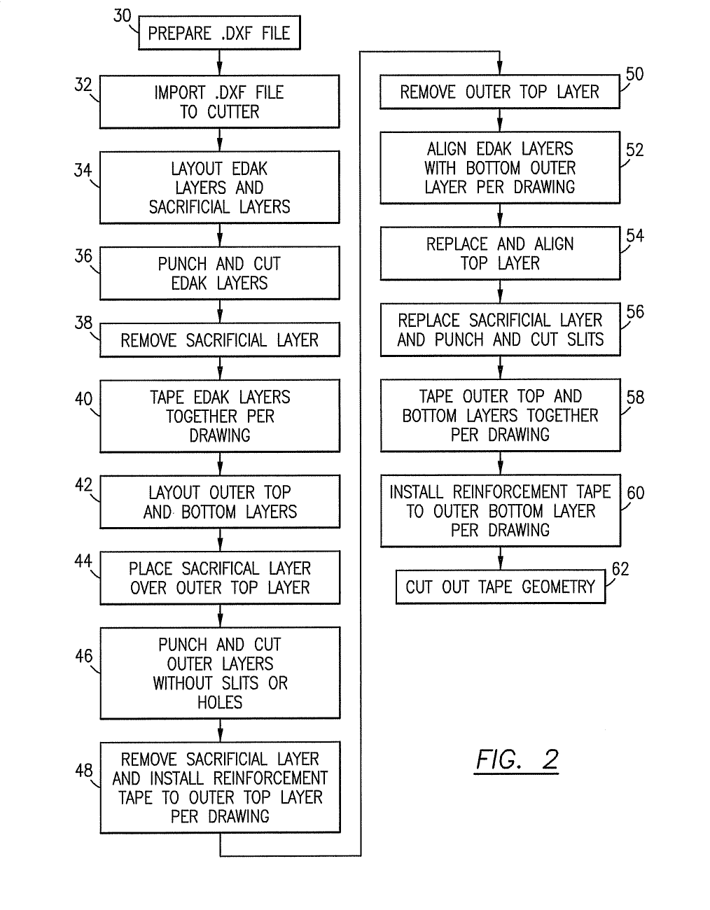

Referring to FIGS. 1 and 2, schematic diagrams are provided containing blocks which are representative of the steps performed in the method of this invention. The term “drawing” appears in a number of the blocks. Depending upon the configuration of a particular space vehicle, MLI blankets must have a given silhouette or peripheral shape, a preferred number of layers, and, a pattern of cuts, slits, holes and the like, in order to closely fit around the structure of the vehicle to be covered. A “drawing” of the MLI blanket is prepared for each structure of the vehicle, and the specifications in that drawing are used in the manufacturing process.

FIG. 1 is a block diagram depiction of the steps employed in the method of this invention for the fabrication of an MLI blanket. Initially, a .dxf file is prepared containing the specifications from the drawing of a given MLI blanket, as discussed above. See block 10. The data from the .dxf file is imported to a cutter, as shown in block 12, which may be one of a number of commercially available, computer controlled cutting apparatus having a vacuum table and a carriage movable with respect to the vacuum table. The carriage mounts a number of cutting devices, such as a drag blade, a wheel blade, a punch and others. Suitable cutting apparatus for use with the punch tool 16 of this invention include Eastman Model No. M9000 commercially available from the Eastman Machine Company of Buffalo, N.Y. and Gerber Model DCS 1500 commercially available from Gerber Technology in Tolland, Conn.

In accordance with the drawing, a number of individual layers of insulating material, typically 3-8 layers, are placed on the vacuum table of the cutting apparatus one on top of the other to form a stack. See block 14. A sacrificial layer, preferably formed of a thin plastic material, is placed over the uppermost layer in the stack. The sacrificial layer functions to hold down the stack of insulation layers on the vacuum table while the cutter performs a punching operation, and/or other cutting operations, to form a pattern of holes and/or other cuts in the stack (and in the sacrificial layer) as depicted in block 16 of FIG. 1.

Blocks 18 and 20 are representative of the next steps in the method of this invention. The sacrificial layer is removed, as shown in block 18, leaving the cut stack on the vacuum table of the cutting apparatus. Because the layers of insulation material forming the MLI blanket are thin, they are subject to tearing or ripping particularly in the area(s) where a hole or other cuts have been formed. In order to protect the blanket, a section of a reinforcing material such as tape, and preferably Kapton tape, is applied by hand to the uppermost layer of the stack over each of the holes or other cuts formed by the cut pattern, as specified in the drawing. See block 20. The tape completely covers the opening(s) and extends over at least the area of the outermost layer of the stack which is immediately adjacent to the opening(s).

Once the initial cutting operation is performed and the tape is in place per the steps denoted by blocks 16-20, the sacrificial layer is placed back onto the stack so that the cut pattern in the sacrificial layer aligns with the same cut pattern in the stack. A second cutting operation is then performed, represented by block 22 in FIG. 1, in which the same cut pattern resulting from the initial cutting operation identified by block 16 is repeated. This removes the tape covering the openings of the cut pattern on the uppermost layer of the stack, but leaves behind the tape applied to the uppermost layer in the areas at least immediately adjacent to the cut pattern. Consequently, the uppermost layer, and the blanket in its entirety, resists tearing and ripping in the area of the cuts due to the presence of the tape. Additionally, the silhouette or overall peripheral shape of the blanket is formed in this second cutting operation.

After the second cutting operation is completed, the sacrificial layer is removed and all layers of the stack are taped together as denoted by block 24. Although this taping operation may vary from one blanket to another depending upon the specifications of the drawing, typically several relatively short sections of a one-sided tape are applied at spaced intervals to the outer edge of the uppermost layer and then each section of tape is folded in half and attached to the outer edge of the lowermost layer of the stack. These sections of tape hold the layers together in between the uppermost and lowermost layers of the stack. By way of example, the dimensions of the tape sections may be approximately ½ inch wide and 1 inch long, and the sections may be spaced 6 inches from one another.

While the method steps discussed above result in the application of tape to the uppermost layer of the stack, it is also desirable to protect the lowermost layer in the stack from rips and tears. A number of individual sections of reinforcing material, e.g. tape, are provided each having a pre-formed opening corresponding to one of the openings formed by the cut pattern in the lowermost layer, which is the same cut pattern as in the rest of the stack. These sections of tape are placed by hand onto the lowermost layer so that the openings in the tape align with a corresponding opening in the lowermost layer. The tape extends outwardly from the openings onto the area of the lowermost layer at least immediately adjacent to the openings, thus providing a rip stop or resistance to tearing or ripping of the lowermost layer in the areas where openings are formed.

Block 28 refers to a hand process which may be required to remove some of the tape which remains over openings in both the uppermost and lowermost layers of the stack, depending on the cuts made in the stack per a particular drawing. For example, if a drawing specifies that a V-shaped notch must be formed in the stack the automated cutting apparatus typically forms a hole and then two slits which intersect the hole at the juncture of the “V.” During the taping operation, a portion of the V-shaped notch will be covered with tape but not all of it is removed during subsequent cutting operations. The tape that remains must be removed by hand with a scalpel or the like to complete the manufacturing operation.

Referring now to FIG. 2, a block diagram is provided depicting the method of manufacturing an MLI blanket according to this invention which is particularly intended to mitigate PIM that may be caused by the blanket. Many of the process steps identified in FIG. 2 are the same as those described above in connection with a discussion of FIG. 1, and the details of same will not be repeated. Generally, the principle difference between the method of manufacturing the MLI blanket of FIG. 1 and the MLI blanket which mitigates PIM illustrated in FIG. 2 involves operations performed on the different layers of the MLI PIM blanket. Whereas all of the layers of the MLI blanket made in accordance with the method shown in FIG. 1 are the same, the MLI PIM blanket made according to FIG. 2 has a number of inner layers, identified as EDAK layers in FIG. 2, which are sandwiched between an outer top layer and an outer bottom layer. The term “EDAK” refers to “embossed double aluminum Kapton.” The inner, EDAK layers have a smaller length and width dimension, or other outer, peripheral dimension (for example, a circumference if the blanket is generally circular in shape) than the outer top and bottom layers. As discussed below, the inner EDAK layers are completely covered by the outer top and bottom layers after the MLI PIM blanket is formed.

Referring now to FIG. 2, the steps denoted by blocks 30 and 32 are the same as described above in connection with a discussion of blocks 10 and 12 of FIG. 1. Additionally, steps 34, 36 and 38 of FIG. 2 performed on the EDAK layers of the MLI PIM blanket are the same as steps 14, 16 and 18, respectively, performed on the layers of the MLI blanket made in accordance with the method of FIG. 1.

Once a cut pattern is made in the EDAK layers and the sacrificial layer is removed, the EDAK layers are taped together in the same manner as the layers of the stack as detailed in connection with a discussion of block 24 in FIG. 1. Discrete sections of Kapton tape, typically on the order of about ½ wide and 1 inch long, are placed at spaced intervals around the periphery of the stack of EDAK layers to secure them together. See block 40 in FIG. 2.

The next steps in the process of FIG. 2 involve working on the outer top and bottom layers of the MLI PIM blanket. The stack of EDAK layers is removed from the vacuum table of the cutting apparatus, and then the outer top and bottom layers are placed on the vacuum table one over the other as represented by block 42. The sacrificial layer is placed over the outer top layer, as represented by block 44, in preparation for a cutting operation. Block 46 represents the cutting operation step, and it is noted that the outer layers are punch and cut “without slits or holes.” As discussed below, the overall shape or silhouette of the MLI PIM blanket, and larger holes and slits, are formed in a cutting operation performed on the outer top and bottom layers and the EDAK layers simultaneously. Consequently, the cutting operation denoted by block 46 does not produce the entire cut pattern of a finished MLI PIM blanket. Instead, it forms the same cut pattern in the outer top and bottom layers as obtained by the cutting operation on the EDAK layers denoted by block 36.

Block 48 denotes the same installation of reinforcement tape step described above in connection with block 20 of FIG. 1, however, in the method of FIG. 2, the outer top layer of the MLI PIM blanket receives tape over the openings resulting from the cutting and punching operation identified by block 46. As in step 20, the reinforcing tape extends along the outer top layer in the areas at least immediately adjacent to the openings therein.

After the tape is installed as indicated in block 48, the outer top layer is removed from the vacuum table of the cutting apparatus leaving the outer bottom layer behind on the table. See block 50. As noted above, the punching and cutting operation of step 46 produces a cut pattern in both the outer top and bottom layers which is the same as that in the EDAK layers resulting from the cutting operation denoted by block 36. The EDAK layers are placed over the outer bottom layer so that the cut pattern in the EDAK layers aligns with the cut pattern in the outer bottom layer. See block 52. As indicated by block 54, the outer top layer is then placed over the EDAK layers such that the cut pattern in the outer top layer aligns with the cut pattern in the EDAK layers and in the outer bottom layer.

With the cut patterns in the top and bottom outer layers and the EDAK layers in alignment with one another, the sacrificial layer is placed back over the outer top layer. A second cutting operation denoted by block 56 is then performed. This second cutting operation is the same as that indicated by block 22 in FIG. 1. The same cut patterns initially formed in all layers are repeated, which removes the majority of the tape placed over the openings formed in the outer top layer. Additionally, various slits, holes and other cuts are made, and the overall shape or silhouette of the MLI PIM blanket is formed, in accordance with the specifications from the drawing.

After completion of the cutting operation identified by block 56, the outer top and bottom layers are connected to one another with the EDAK layers between them forming essentially a sandwich. In the presently preferred embodiment, the outer top and bottom layers are connected to one another in a two-step taping operation. Initially, a two-sided tape is applied to the inner surface of the outer bottom layer along the entire length of its peripheral edge. The outer top layer is then placed into engagement with the two-sided tape so that the inner surface of its peripheral edge is affixed to the outer bottom layer. Next, approximately half of the width of a one-sided tape is affixed to the outer surface of the peripheral edge of the outer bottom layer along the entire length of such peripheral edge. The one-sided taped in then folded in half, onto the outer surface of the peripheral edge of the outer top layer, to connect to the outer top and bottom layers together. It should be noted that while the EDAK layers are connected to one another by sections of tape placed at intervals about their peripheries, both the two-side tape and the one-sided tape which connect the outer top and bottom layers extend continuously along the peripheries thereof.

With all layers of the blanket connected together in the manner described above, the blanket is turned over to expose the outer bottom layer. As indicated in block 60, reinforcement tape is then applied to openings formed by the cut patterns in the outer bottom layer in the same manner as described in connection with a discussed of block 26 of FIG. 1. Finally, step 62 is performed on the MLI PIM blanket in the same manner as step 28 of FIG. 1.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. The method of making a multi-layer insulation blanket, comprising:
(a) placing a number of individual layers of insulation material, one on top of another, to form a stack having an outermost first layer and an outermost second layer;
(b) forming cut patterns in the stack;
(c) protecting the outermost first layer from rips and tears in the areas of the cut patterns;
(d) connecting the layers of the stack together; and
(e) protecting the outermost second layer from rips and tears in the areas of the cut patterns.

2. The method of claim 1 in which step (c) includes:
applying a reinforcing material to the outermost first layer over the cut patterns including the area of the outermost first layer at least immediately adjacent to the cut patterns; and
repeating step (b) to remove the reinforcing material from the cut patterns.

3. The method of claim 1 farther comprising holding down the stack with a sacrificial layer placed over the outermost first layer in the course of performing step (b).

4. The method of claim 1 in which step (e) includes providing discrete sections of tape material each having a pre-cut pattern corresponding to one of the cut patterns in the stack, and applying the discrete sections of tape material to the outermost second layer of the stack over respective cut patterns.

5. The method of claim 1 in which step (d) includes affixing a portion of the width of a number of sections of one-sided tape at spaced intervals along the outside peripheral edge of one of the outermost first and second layers, and then folding the one-sided tape over onto the outside peripheral edge of the other of the outermost first and second layers to connect the layers in the stack together.

6. The method of making a multi-layer insulation blanket, comprising:
(a) placing a number of individual layers of insulation material, one on top of another, to form a stack having an outermost first layer and an outermost second layer;
(b) covering the outermost first layer with a sacrificial layer;
(c) operating a cutting device to engage the sacrificial layer and then the stack to form cut patterns in the stack;
(d) applying a reinforcing material to the outermost first layer over the cut patterns including the area of the outermost first layer at least immediately adjacent to the cut patterns;
(e) repeating steps (b) and (c) to remove the tape material from the cut patterns;
(f) connecting the layers of the stack together; and
(g) applying a reinforcing material to the outermost second layer over the cut patterns including the area of the outermost second layer at least immediately adjacent to the cut patterns.

7. The method of claim 6 in which step (b) includes covering the outermost first layer with a layer of plastic material.

8. The method of claim 6 in which step (c) includes operating a cutting apparatus having a drag blade, a wheel blade and a punch to form the cut patterns.

9. The method of claim 6 in which step (g) includes providing discrete sections of tape material, each having a pre-cut pattern corresponding to one of the cut patterns in the stack, and applying the discrete sections of tape material to the outermost second layer of the stack over respective cut patterns.

10. The method of claim 6 in which step (f) includes affixing a portion of the width of a number of sections of one-sided tape at spaced intervals along the outside peripheral edge of one of the outermost first and second layers, and then folding the one-sided tape over onto the outside peripheral edge of the other of the outermost first and second layers to connect the layers in the stack together.

11. The method of fabricating a multi-layer insulation blanket in which, pulse intermodulation is reduced, comprising:
(a) placing a number of individual inner layers, one on top of another, to form a stack;
(b) forming first cut patterns in the stack;
(c) connecting the layers of the stack together;
(d) forming the first cut patterns of step (b) in a first outer layer and a second outer layer;
(e) placing the stack over the second outer layer so that the cut patterns in the stack and the second outer layer align;
(f) placing the first outer layer over the stack so that the cut patterns in the stack and the first outer layer align;
(g) forming second cut patterns in the first and second outer layers and in the stack;
(h) connecting the first and second outer layers to one another with the stack between them;
(i) protecting at least one of the first and second outer layers from rips and tears in the areas of the first and second cut patterns.

12. The method of claim 11 further including positioning a sacrificial layer over the stack in advance of performing step (b).

13. The method of claim 11 further including positioning a sacrificial layer over the first outer layer in advance of performing steps (d) and (g).

14. The method of claim 11 in which step (i) comprises applying a reinforcing material over the first outermost layer in advance of step (g).

15. The method of claim 11 in which step (i) comprises providing discrete sections of reinforcing material each having a pre-cut pattern corresponding to one of the first and second cut patterns in the second outer layer, and applying the discrete sections of reinforcing material to the second outer layer over respective first and second cut patterns.

16. The method of claim 11 in which step (h) includes affixing a two-sided tape along the inside peripheral edge of one of the first and second outer layers and engaging the inside peripheral edge of the other of the first and second with the two-sided tape to connect the inside peripheral edges of the first and second outer layers together.

17. The method of claim 11 in which step (h) includes affixing a portion of the width of a one-sided tape to the outside peripheral edge of one of the first and second outer layers, and then folding the one-sided tape over onto the outside peripheral edge of the other of the first and second outer layers to seal them together.

18. The method of claim 11 in which step (c) includes affixing a portion of the width of a number of sections of one-sided tape at spaced intervals along the outside peripheral edge of one of the outermost layers of the stack, and then folding the one-sided tape over onto the outside peripheral edge of the other of the outermost layers of the stack to connect all layers in the stack together.
